(19) United States
(12) Patent Application Publication
(10) Pub. No.: US 2024/0321246 A1
(43) Pub. Date: Sep. 26, 2024

(54) HANDWRITING NUMBERED MUSICAL NOTATION RECOGNITION SYSTEM

(71) Applicant: Jian Ming Zhung, Shenzhen (CN)

(72) Inventor: Jian Ming Zhung, Shenzhen (CN)

(21) Appl. No.: 18/125,745

(22) Filed: Mar. 24, 2023

(51) Int. Cl. G10H 1/00; G06V 30/12; G06V 30/304

(52) U.S. Cl. CPC G10H 1/0041; G06V 30/133; G06V 30/304; G10H 2240/005; G10H 2240/021; G10H 2240/056

(57) ABSTRACT

A handwriting numbered musical notation recognition system includes: a coding rules database; a music file database for storing a large numbers of music expression files which are collected and edited by computer used formats; a conversion unit for converting music expression files into numbered musical notation files; a handwriting database for storing relations between music symbols and handwriting trace data for numbered musical notations, and a handwriting combination unit connected to the handwriting trace database and the numbered musical notation coding sequences database; and a handwriting numbered musical notation recognition model used for recognition of the handwriting sequence. The music creation can be easily retained by electronic forms, while the creators still can create his (or her) music creations by handwriting. Furthermore, the recognition of the present invention supports the use of MusicXML formats, MIDI formats, or other computer formats.

### FIELD OF THE INVENTION

The present invention is related to handwriting music notations, and in particular to a handwriting numbered musical notation recognition system.

### BACKGROUND OF THE INVENTION

Numbered musical notations for music have the advantages of easy to write the music and easy to read of the music so that it is popular for musicians and other people.

In the prior art, the creators of the music recode created music on paper sheets by handwriting, and these sheets are used for storing and spread the sheet music. Currently, some sheet music editing software are developed, which are used in creation of music. The sheet music is stored as a computer file, which is formed of drawings or computer files with music expression formats.

For the prior art which record sheet music on paper, although it has the advantage of convenience in creation, it is inconvenient for storage.

Generally, if the paper is destroyed or lost, the sheet music will be incomplete or lost. However, computer music expression files can overcome these defects, and they have advantages of easy usage and convenience for spreading. While in many cases, the creators have no computer in hand so they create music in paper by handwriting and using numbered musical notations. As a result, there is an eager demand for converting the handwriting traces of music into computer accepted formats, that is to store the music expression files by computer acceptable formats.

Therefore, the object of the present invention is to provides a handwriting numbered musical notation recognition system to over

### SUMMARY OF THE INVENTION

Accordingly, the object of the present invention is to provide a handwriting numbered musical notation recognition system, wherein the music creation can be easily retained by electronic forms, while the creators still can create his (or her) music creations by handwriting. Furthermore, the recognition of the present invention supports the use of MusicXML formats, MIDI formats, or other computer formats. Therefore, retaining and spreading of music are easy and convenient. Furthermore, the way of coding of the present invention considers the presence of music notes so that the user can retain the habits of handwriting. Therefore, the present invention is a usable for user in creation of music.

To achieve above object, the present invention provides a handwriting numbered musical notation recognition system, comprising: a coding rules database for providing coding rules for coding known musical symbols, wherein the coding rules comprises codes corresponding to musical symbols and division symbols for isolation of the musical symbols; a music file database for storing a large numbers of music expression files which are collected and edited by computer used formats for edition of music; a conversion unit connected to the music file database; the conversion unit which are used to convert music expression files in the music file database into numbered musical notation files based on the conversion rules; the music files in the music file database having the computer used formats; then the coding rules in the coding rules database being used to convert the musical notation files into respective numbered musical notation coding sequence which are then stored in a numbered musical notation coding sequence database; a handwriting database for storing relations between music symbols and handwriting trace data for numbered musical notations, and the basic codes and basic coding blocks as defined above; and a handwriting combination unit connected to the handwriting trace database and the numbered musical notation coding sequences database; based on the musical symbol handwriting traces in the handwriting database and the numbered musical notation coding sequences of music files in the numbered musical notation coding sequences database, each musical symbol in the numbered musical notation coding sequences being formed with respective handwriting trace so as to acquire a handwriting sequence which are similar to a real handwriting numbered musical notation, which are stored in a musical notation database; and, the numbered musical notation coding sequences of the handwriting sequence is as a label sequence which is also stored in the musical notation database; and the handwriting sequence and respective label sequence being formed as a label set; by above mentioned way, a large number of label sets can be obtained, which are used in training a recognition model; and a handwriting numbered musical notation recognition model used for recognition of the handwriting sequence; firstly, the data being classified into a training set, a certified set and a testing set; the training set being used to train a recognition model, the certified set being used to certify the recognition model, and the test set being used to test the recognition model to obtain a quality of the recognition model to determine whether the recognition model is satisfied to a preset value.

### BRIEF DESCRIPTION OF THE DRAWINGS

FIG. 1 is a block diagram showing the structure of the present invention in training stage.

FIG. 2 shows a detail structure of the present invention in FIG. 1.

FIG. 3 is a system flow diagram showing that the present invention is in a predict stage.

FIG. 4 shows the operation flow diagram of the present invention.

FIG. 5 shows the hardware structure of the invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

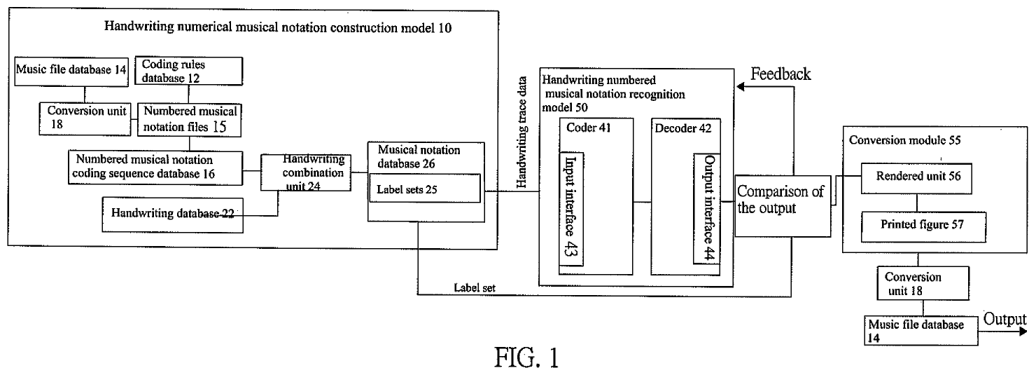

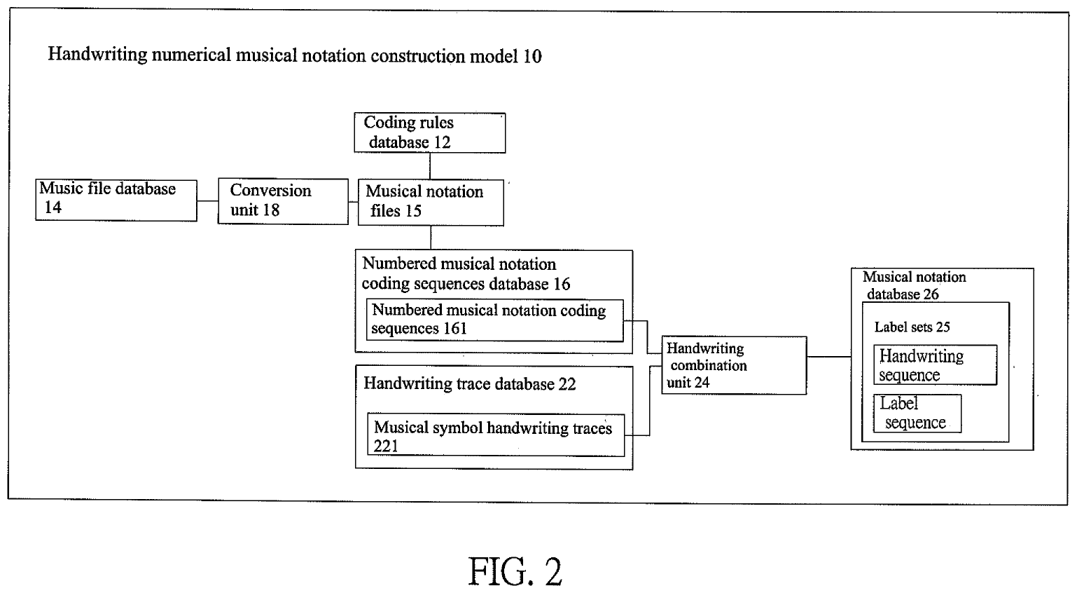

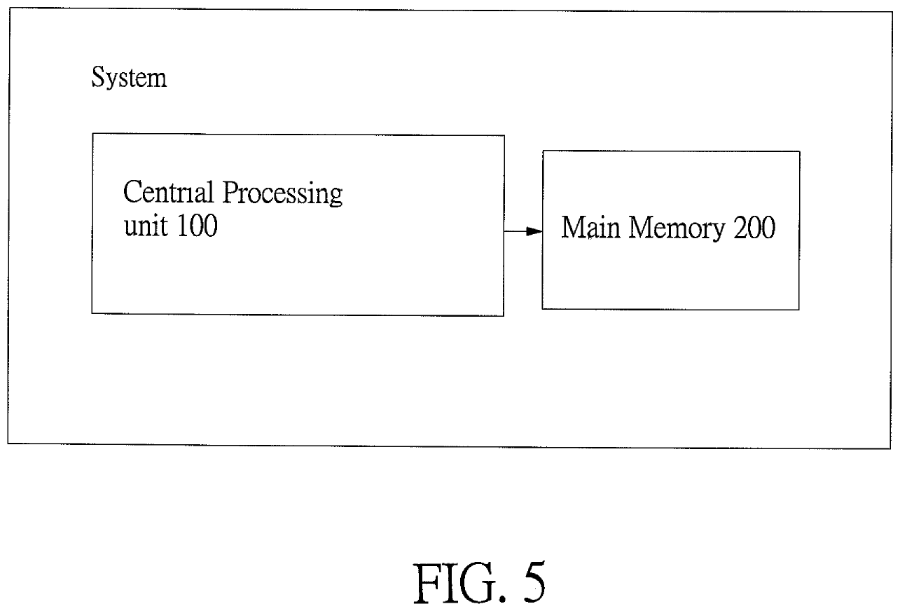

Referring to FIGS. 1 to 4, system of the present invention with the handwriting the numbered musical notation is illustrated. The system of the present invention includes a central processing unit 100 and a main memory 200, as illustrated in FIG. 5. The main memory 200 serves to store software necessary in the present invention and the central processing unit 100 serves to perform the processes used in the present invention.

The system further includes the following elements:

A handwriting numerical musical notation construction model 10 comprises the following elements.

A coding rules database 12 provides coding rules to the handwriting numerical musical notation construction model 10 for coding known musical symbols (step 510), wherein the coding rules comprises codes corresponding to musical symbols and division symbols for isolation of the musical symbols.

In the coding rules, each musical symbol has a corresponding code. The musical symbols include pitches, pauses, extensions, barlines, borders, end lines, repeat symbols, and other music symbols. These codes are used as basic codes. The symbols around the musical symbols are also coded based on the code rules. Then these symbols around the musical symbol are arranged in front of or in a rear side of the musical symbol so as to construct as a basic coding block.

A dividing symbol is used to divide two adjacent basic coding blocks. These basic coding blocks are arranged based on the sequence of the musical symbols corresponding to the basic coding blocks to as to acquire a numbered musical notation coding sequence.

The numbered musical notation coding sequence may be expressed by the following ways.

The basic code includes at least one of codes for pitches, codes for pauses, codes for extensions, codes for barlines, codes for borders, codes for end lines, codes for repeat symbols, and codes for other music symbols.

Basic coding block=[symbol code at a left side of a music symbol][symbol code at an upper side of a music symbol][basic code][symbol coding at a lower side of a music symbol][symbol code at a right side of a music symbol]

About sequence is not used to confine the scope of the present invention. The user can adjust the sequence of the symbol codes and the basic code as desired.

Numbered musical notation Coding sequence=[basic coding block] dividing code [basic coding block]dividing code[basic coding block] The dividing codes are used to divide the basic coding blocks.

A music file database 14 serves for storing a large numbers of music expression files which are collected and have MusicXML format, MIDI format, and others.

A conversion unit 18 is connected to the music file database 14. The conversion unit 18 which are used to convert music expression files in the music file database 14 into numbered musical notation files 15 based on the conversion rules. The music files in the music file database 14 have the MusicXML format, MIDI format, and other known formats and the conversion rules are known in the prior arts. Then the coding rules in the coding rules database 12 are used to convert the musical notation files 15 into respective numbered musical notation coding sequence which are then stored in a numbered musical notation coding sequence database 16 (step 520).

The conversion rules in the conversion unit 18 serve to perform the conversion of music symbols in the music expression files with computer used formats (such as MusicXML formats, MIDI formats, and others) into numbered musical notations. This is known in the prior art and thus the details will not be further described herein.

By above mentioned conversion rules and coding rules, the music expression files with MusicXML formats and MIDI formats, and others and the numbered musical notation coding sequences can be converted to one another. Therefore, a training set for a handwriting numerical musical notation construction model can be formed.

Similarly, based on a reverse conversion, the numbered musical notation coding sequences can be converted to a music expression file with MusicXML formats and MIDI formats, and others so as to support the common use, edition, hearing, etc. of the numbered musical notations A handwriting database 22 serves for storing relations between music symbols and handwriting trace data for numbered musical notations, and the basic codes and basic coding blocks as defined above (step 530). The handwriting trace data at least contains point coordinates S={(x1,y1),(x2,y2), . . . ,(xn,yn)} for each trace of a handwriting, where coordinate (x1,y1) expresses an initial point of the trace, and (xn,yn) expresses a final point of the trace.

A handwriting combination unit 24 is connected to the handwriting trace database 22 and the numbered musical notation coding sequences database 16. Based on the musical symbol handwriting traces 221 in the handwriting database 22 and the numbered musical notation coding sequences 161 of music files in the numbered musical notation coding sequences database 16, each musical symbol in the numbered musical notation coding sequences 161 is formed with respective handwriting trace so as to acquire a handwriting sequence which is similar to a real handwriting numbered musical notation, which is stored in a musical notation database 26 (step 240). And, the numbered musical notation coding sequences of the handwriting sequence is as a label sequence which is also stored in the musical notation database 26. The handwriting sequence and respective label sequence are formed as a label set 25.

By above mentioned way, a large number of label sets 25 can be obtained, which are used in training of a neural net.

A handwriting numbered musical notation recognition model 50 is used for recognition of the handwriting sequence. Firstly, the data are classified into a training set, a certified set and a testing set. The training set serves to train a recognition model, the certified set is used to certify the recognition model, and the test set is used to test the recognition model to obtain the quality of the recognition model to determine whether the recognition model is satisfied to a preset value.

Basically, the handwriting numbered musical notation recognition model 50 is a neural network which includes a coder 41 and a decoder 42, an input interface 43 in the coder 41 and an output interface 44 in the decoder 42. The input interface 43 is connected to the musical notation database 26 for receiving the handwriting sequence which is then entered into the coder 41. The coder 41 will capture the features in the handwriting sequence and the features captured are inputted to the decoder 42 which will predict a pro-label sequence. The predicted pro-label sequence is compared with a label sequence stored in the musical notation database 26 and corresponding to the handwriting sequence inputted to the coder 41. The difference therebetween is used to modify the coefficients (weightings) in the neural network. The process is repeated for training the neural network to a desired level (step 550)

After the recognition model is trained the model is used in the recognition of handwriting numbered musical notation and the recognized results are rendered so as to be converted to respective music expressive files with MusicXML formats or MIDI formats, or other music formats (step 560).

Therefore, the present invention further includes an analytic and conversion module 55 which is connected to the handwriting numbered musical notation recognition model 50. The recognized results from the handwriting numbered musical notation recognition model 50 is the numbered musical notation coding sequences which is input into a rendered unit 56 for rendering. The recognition result should include at least one musical symbol in the handwriting numbered musical notation and positions of these musical symbols. The recognition results are used to the operation of rendering so as to obtain a printed FIG. 57 of the handwriting numbered musical notation. Then by the converting rules in the conversion unit 18, the output of the rendering unit 57 is converted into music expression files with MusicXML formats, MIDI formats, or other computer formats.

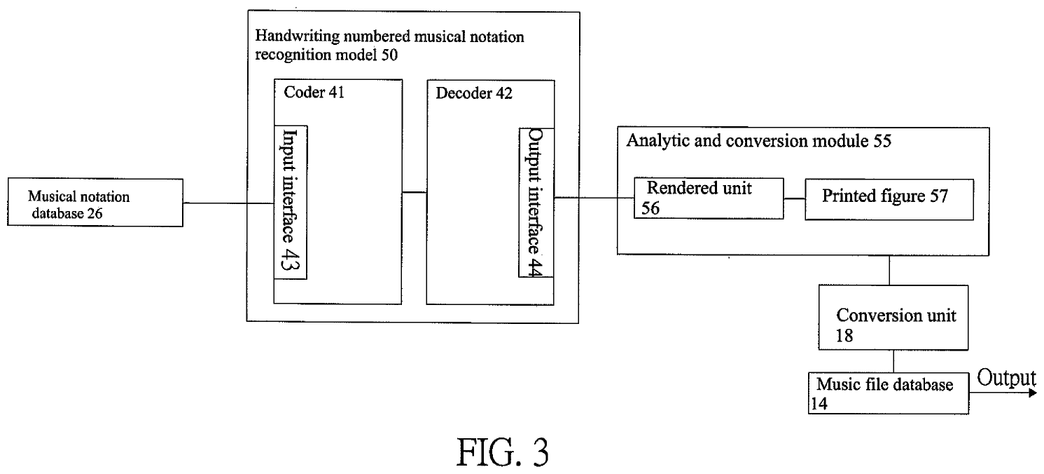

FIG. 3 is a flow diagram showing the testing process of the handwriting numbered musical notation recognition model after training.

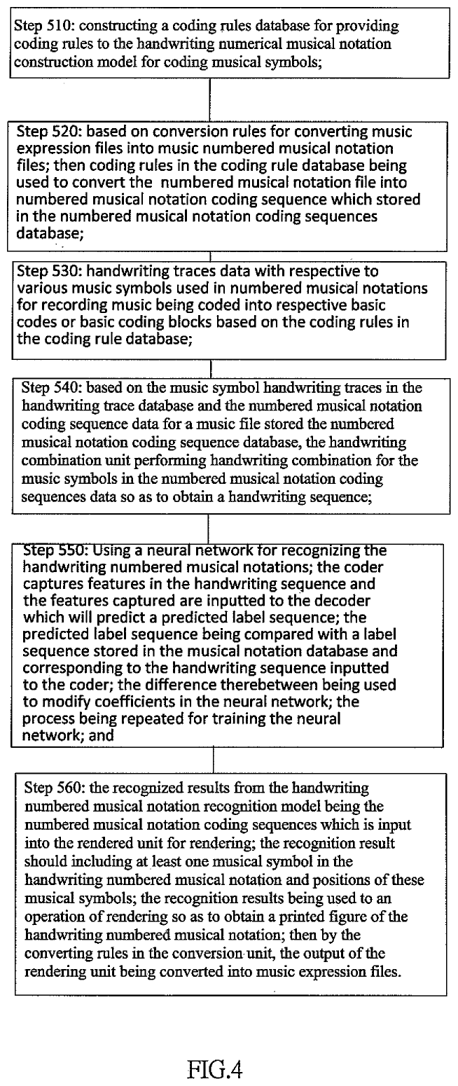

FIG. 4 shows the recognition process of the handwriting numbered musical notation recognition model, in that the coder obtains the apparent features of the handwriting numbered musical notation data and then the decoder predicts the coding sequence based on the apparent features obtained in the coder.

The present invention further includes the method for recognition of the handwriting numbered musical notations, referring to FIG. 4, the method includes the following steps.

Step 510: A coding rules database 12 is constructed for providing coding rules to the handwriting numerical musical notation construction model 10 for coding known musical symbols.

Step 520: Based on conversion rules for converting music expression files with MusicXML formats, MIDI formats, or other computer formats into music numbered musical notation files 15; then coding rules in the coding rule database 12 is used to converting the numbered musical notation file into numbered musical notation coding sequence which stored in the numbered musical notation coding sequences database 16.

Step 530: handwriting traces data with respective to various music symbols used in numbered musical notations for recording music is coded into respective basic codes or basic coding blocks based on the coding rules in the coding rule database 12.

Step 540: Based on the music symbol handwriting traces 221 in the handwriting trace database 22 and the numbered musical notation coding sequence data 161 for a music file stored the numbered musical notation coding sequence database, the handwriting combination unit 24 performs handwriting combination for the music symbols in the numbered musical notation coding sequences data 161 so as to obtain a handwriting sequence; Step 550: The neural network is used for recognizing a handwriting numbered musical notations. The coder 41 will capture the features in the handwriting sequence and the features captured are inputted to the decoder 42 which will predict a pro-label sequence. The predicted pro-label sequence is compared with a label sequence stored in the musical notation database 26 and corresponding to the handwriting sequence inputted to the coder 41. The difference therebetween is sued to modify the coefficients (weightings) in the neural network. The process is repeated for training the neural network.

Step 560: The recognized results from the handwriting numbered musical notation recognition model 50 is the numbered musical notation coding sequences which is input into the rendered unit 56 for rendering. The recognition result should include at least one musical symbol in the handwriting numbered musical notation and positions of these musical symbols. The recognition results are used to the operation of rendering so as to obtain a printed FIG. 57 of the handwriting numbered musical notation. Then by the converting rules in the conversion unit 18, the output of the rendering unit 57 is converted into music expression files with MusicXML formats, MIDI formats, or other computer formats.

Advantages of the present invention is that the music creation can be easily retained by electronic forms, while the creators still can create his (or her) music creations by handwriting. Furthermore, the recognition of the present invention supports the use of MusicXML formats, MIDI formats, or other computer formats. Therefore, retaining and spreading of music are easy and convenient. Furthermore, the way of coding of the present invention considers the presence of music notes so that the user can retain the habits of handwriting. Therefore, the present invention is a usable for user in creation of music.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A handwriting numbered musical notation recognition system, the system including a central processing unit and a main memory; the main memory serving to store software necessary used and the central processing unit serving to perform the processes used, the system comprising:
a coding rules database for providing coding rules for coding known musical symbols, wherein the coding rules comprises codes corresponding to musical symbols and division symbols for isolation of the musical symbols;
a music file database for storing a large numbers of music expression files which are collected and edited by computer used formats for edition of music;
a conversion unit connected to the music file database; the conversion unit which are used to convert music expression files in the music file database into numbered musical notation files based on the conversion rules; the music files in the music file database having the computer used formats; then the coding rules in the coding rules database being used to convert the musical notation files into respective numbered musical notation coding sequence which are then stored in a numbered musical notation coding sequence database;
a handwriting database for storing relations between music symbols and handwriting trace data for numbered musical notations, and the basic codes and basic coding blocks as defined above;
a handwriting combination unit connected to the handwriting trace database and the numbered musical notation coding sequences database; based on the musical symbol handwriting traces in the handwriting database and the numbered musical notation coding sequences of music files in the numbered musical notation coding sequences database, each musical symbol in the numbered musical notation coding sequences being formed with respective handwriting trace so as to acquire a handwriting sequence which are similar to a real handwriting numbered musical notation, which are stored in a musical notation database; and, the numbered musical notation coding sequences of the handwriting sequence is as a label sequence which is also stored in the musical notation database; and the handwriting sequence and respective label sequence being formed as a label set; by above mentioned way, a large number of label sets can be obtained, which are used in training a recognition model; and
a handwriting numbered musical notation recognition model used for recognition of the handwriting sequence; firstly, the data being classified into a training set, a certified set and a testing set; the training set being used to train a recognition model, the certified set being used to certify the recognition model, and the test set being used to test the recognition model to obtain a quality of the recognition model to determine whether the recognition model is satisfied to a preset value.

2. The handwriting numbered musical notation recognition system as claimed in claim 1, wherein after the recognition model is trained, the model is used in the recognition of handwriting numbered musical notation and the recognized results are rendered so as to be converted to respective music expressive files.

3. The handwriting numbered musical notation recognition system as claimed in claim 1, wherein the handwriting numbered musical notation recognition model is a neural network which includes a coder and a decoder, an input interface in the coder and an output interface in the decoder; the input interface is connected to the musical notation database for receiving the handwriting sequence which is then entered into the coder; the coder will capture the features in the handwriting sequence and the features captured are inputted to the decoder which will predict a pro-label sequence. The predicted pro-label sequence is compared with a label sequence stored in the musical notation database and corresponding to the handwriting sequence inputted to the coder; the difference therebetween is used to modify the coefficients in the neural network; the process is repeated for training the neural network to a desired level.

4. The handwriting numbered musical notation recognition system as claimed in claim 1, wherein in the coding rules, each musical symbol has a corresponding code; the musical symbols include pitches, pauses, extensions, barlines, borders, end lines, repeat symbols, and other music symbols; these codes are used as basic codes; the symbols around the musical symbols are also coded based on the code rules; then these symbols around the musical symbol are arranged in front of or in a rear side of the musical symbol so as to construct as a basic coding block; a dividing symbol is used to divide two adjacent basic coding blocks; these basic coding blocks are arranged based on the sequence of the musical symbols corresponding to the basic coding blocks to as to acquire a numbered musical notation coding sequence.

5. The handwriting numbered musical notation recognition system as claimed in claim 4, wherein the basic code includes at least one of codes for pitches, codes for pauses, codes for extensions, codes for barlines, codes for borders, codes for end lines, codes for repeat symbols, and codes for other music symbols; and
basic coding block=[symbol code at a left side of a music symbol][symbol code at an upper side of a music symbol][basic code][symbol coding at a lower side of a music symbol][symbol code at a right side of a music symbol]; and
orders of the symbol codes in above equation are changeable;
numbered musical notation Coding sequence=[basic coding block] dividing code [basic coding block]dividing code[basic coding block]

6. The handwriting numbered musical notation recognition system as claimed in claim 1, wherein the music expression files are edited by MusicXML format, MIDI format, or others computer used formats for edition of music.

7. The handwriting numbered musical notation recognition system as claimed in claim 1, further comprising an analytic and conversion module which is connected to the handwriting numbered musical notation recognition model; wherein the recognized results from the handwriting numbered musical notation recognition model is the numbered musical notation coding sequences which are input into a rendered unit for rendering; the recognition result should include at least one musical symbol in the handwriting numbered musical notation and positions of these musical symbols; the recognition results are used to the operation of rendering so as to obtain a printed figure of the handwriting numbered musical notation; then by converting rules in the conversion unit, the output of the rendering unit is converted into music expression files with computer formats for edition of music.

8. A method for recognition of the handwriting numbered musical notations by using the system of claim 1, comprising the following step of:
Step 510: constructing a coding rules database for providing coding rules to the handwriting numerical musical notation construction model for coding musical symbols;
Step 520: based on conversion rules for converting music expression files into music numbered musical notation files; then coding rules in the coding rule database being used to convert the numbered musical notation file into numbered musical notation coding sequence which stored in the numbered musical notation coding sequences database;
Step 530: handwriting traces data with respective to various music symbols used in numbered musical notations for recording music being coded into respective basic codes or basic coding blocks based on the coding rules in the coding rule database;
Step 540: based on the music symbol handwriting traces in the handwriting trace database and the numbered musical notation coding sequence data for a music file stored the numbered musical notation coding sequence database, the handwriting combination unit performing handwriting combination for the music symbols in the numbered musical notation coding sequences data so as to obtain a handwriting sequence;
Step 550: Using a neural network for recognizing the handwriting numbered musical notations; the coder captures features in the handwriting sequence and the features captured are inputted to the decoder which will predict a predicted label sequence; the predicted label sequence being compared with a label sequence stored in the musical notation database and corresponding to the handwriting sequence inputted to the coder; the difference therebetween being used to modify coefficients in the neural network; the process being repeated for training the neural network; and
Step 560: the recognized results from the handwriting numbered musical notation recognition model being the numbered musical notation coding sequences which is input into the rendered unit for rendering; the recognition result should including at least one musical symbol in the handwriting numbered musical notation and positions of these musical symbols; the recognition results being used to an operation of rendering so as to obtain a printed figure of the handwriting numbered musical notation; then by the converting rules in the conversion unit, the output of the rendering unit being converted into music expression files.

9. The method as claimed in claim 8, wherein after the recognition model is trained, the model is used in the recognition of handwriting numbered musical notation and the recognized results are rendered so as to be converted to respective music expressive files.

10. The handwriting numbered musical notation recognition system as claimed in claim 8, wherein the music expression files have one of MusicXML format, MIDI format, and others computer used formats for edition of music.
